(19) United States
(12) Patent Application Publication
(10) Pub. No.: US 2015/0002045 A1
(43) Pub. Date: Jan. 1, 2015

(54) LIGHT EMITTING DIODE DRIVING APPARATUS AND LIGHT EMITTING DIODE LIGHTING APPARATUS

(71) Applicant: SAMSUNG ELECTRO-MECHANICS CO., LTD., Suwon (KR)

(72) Inventors: Jong Tae HWANG, Suwon (KR); Sang Hyun CHA, Suwon (KR); Chan Woo PARK, Suwon (KR); Je Hyeon YU, Suwon (KR); Deuk Hee PARK, Suwon (KR); Chang Seok LEE, Suwon (KR); Yun Joong LEE, Suwon (KR)

(73) Assignee: SAMSUNG ELECTRO-MECHANICS CO., LTD., Suwon (KR)

(21) Appl. No.: 14/029,028

(22) Filed: Sep. 17, 2013

(30) Foreign Application Priority Data
Jun. 27, 2013 (KR) 10-2013-0074456

(51) Int. Cl. H05B 33/08

(52) U.S. Cl. CPC H05B 33/0815
USPC 315/291

(57) ABSTRACT

There are provided a light emitting diode driving apparatus and a light emitting diode lighting apparatus capable of absorbing a noise current generated according to power of a phase control of a dimmer. The light emitting diode lighting apparatus includes: a dimmer controlling a phase of an alternating current (AC) power; a power supplying unit receiving the phase-controlled power from the dimmer and supplying a preset driving power; a driving unit receiving the driving power from the power supplying unit to drive a light emitting diode unit receiving the phase-controlled power; and a noise current absorbing unit suppressing an increase in a voltage level of the driving power supplied to the driving unit by the phase-controlled power.

### CROSS-REFERENCE TO RELATED APPLICATIONS

This application claims the priority of Korean Patent Application No. 10-2013-0074456 filed on Jun. 27, 2013, in the Korean Intellectual Property Office, the disclosure of which is incorporated herein by reference.

### BACKGROUND OF THE INVENTION

1. Field of the Invention

The present invention relates to a light emitting diode driving apparatus, and more particularly, to a light emitting diode lighting apparatus using a dimmer controlling a phase of alternating current (AC) power.

2. Description of the Related Art

A light emitting diode (LED), a semiconductor device formed as a p-n junction structure and emitting light through the recombination of electrons and holes has been recently applied to various technological fields in accordance with the continuing development of semiconductor technology.

Particularly, since the LED has a higher efficiency and a longer lifespan and is more environment-friendly as compared with existing light emitting devices, fields to which the LED is applied have continuously increased.

Generally, the LED may be driven by having direct current (DC) power of several volts applied thereto, in view of a structure thereof. Therefore, generally, in order to drive an LED with commercially-available alternating current (AC) power used domestically, commercially, industrially, or the like, a separate unit is required.

In order to drive the LED using commercially-available AC power, an LED driving apparatus generally includes a rectifying circuit, an AC to DC converter, and the like.

In the case in which the LED driving apparatus uses DC power, a circuit for providing the DC power may be complicated.

Therefore, a scheme in which a power generated by rectifying AC power is directly used to drive the LED has been suggested.

Meanwhile, a lighting apparatus using the LED uses a dimmer controlling the emission of light by the LED by converting the AC power according to a dimming signal. The dimmer may control the light emission of the LED by controlling a phase of the AC power as disclosed in the following Related Art Document.

In the LED driving apparatus, particularly, the lighting apparatus using the LED, a significantly high pulse current may be generated in a period in which an input power rises due to dimming by the phase control, which applies stress to the dimmer and the light emitting diode which may have a negative influence on reliability.

### RELATED ART DOCUMENT

(Patent Document 1) Korean Patent Publication No. 10-1008850

### SUMMARY OF THE INVENTION

An aspect of the present invention provides a light emitting diode driving apparatus and a light emitting diode lighting apparatus capable of absorbing a noise current generated according to power of a phase control of a dimmer.

According to an aspect of the present invention, there is provided a light emitting diode driving apparatus including: a power supplying unit receiving a phase-controlled power and supplying a preset driving power; a driving unit receiving the driving power from the power supplying unit to drive a light emitting diode unit receiving the phase-controlled power; and a noise current absorbing unit suppressing an increase in a voltage level of the driving power supplied to the driving unit by the phase-controlled power.

The driving unit may include at least one driver driving a corresponding light emitting diode, wherein the at least one driver includes: a switching unit having a switch switching a path of a current flowing to a corresponding light emitting diode of the light emitting diode unit; and a driving controlling unit receiving the driving power and comparing a detection voltage obtained by detecting the current flowing to the light emitting diode by conduction of the switch with a preset reference voltage to control driving of the corresponding switching unit.

The light emitting diode unit may include a plurality of light emitting diodes connected to each other in series, and the driving unit may include a plurality of drivers driving corresponding light emitting diodes, respectively, wherein each of the plurality of drivers includes: a switching unit switching a switch switching a path of a current flowing to the corresponding light emitting diode; and a driving controlling unit receiving the driving power and comparing a detection voltage obtained by detecting the current flowing to the light emitting diode by conduction of the switch with a preset reference voltage to control driving of the corresponding switching unit.

The noise current absorbing unit may absorb a current flowing to a parasitic capacitor of the switch to suppress an increase in a voltage level of the driving power supplied to the driving unit.

The noise current absorbing unit may include: a first capacitor charged with the phase-controlled power; a first resistor providing a voltage according to a current flowing from the first capacitor; and a current absorbing switch receiving the voltage from the first resistor at agate thereof to thereby be conducted and absorbing a current flowing backward to the power supplying unit due to parasitic capacitance of the switch.

The noise current absorbing unit may include: a first switch receiving the phase-controlled power; a first resistor providing a voltage according to a current flowing due to parasitic capacitance of the first switch; a second switch receiving the voltage from the first resistor at a gate thereof to thereby be conducted; and a current absorbing switch receiving the voltage from the first resistor at a gate thereof to thereby be conducted and absorbing a current flowing backward to the power supplying unit due to parasitic capacitance of the switch according to a preset ratio between the first and second switches.

According to another aspect of the present invention, there is provided a light emitting diode lighting apparatus including: a dimmer controlling a phase of an alternating current (AC) power; a power supplying unit receiving the phase-controlled power from the dimmer and supplying a preset driving power; a driving unit receiving the driving power from the power supplying unit to drive a light emitting diode unit receiving the phase-controlled power; and a noise current absorbing unit suppressing an increase in a voltage level of the driving power supplied to the driving unit by the phase-controlled power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic circuit diagram illustrating a light emitting diode driving apparatus or a light emitting diode lighting apparatus according to an embodiment of the present invention;

FIG. 2 is a schematic circuit diagram illustrating a light emitting diode driving apparatus or a light emitting diode lighting apparatus according to another embodiment of the present invention;

FIG. 3 is a view illustrating a generation of a noise current; and

FIG. 4 is a graph illustrating electrical characteristics of the light emitting diode driving apparatus or the light emitting diode lighting apparatus according to the embodiment of the present invention.

### DETAILED DESCRIPTION OF THE EMBODIMENTS

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

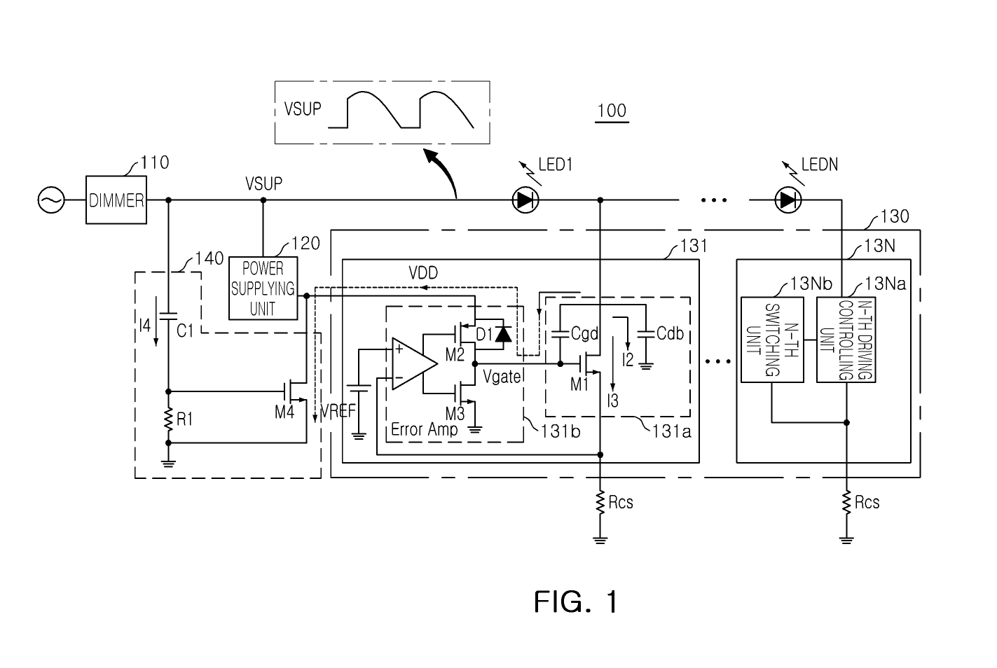

FIG. 1 is a schematic circuit diagram illustrating a light emitting diode driving apparatus or a light emitting diode lighting apparatus according to an embodiment of the present invention.

Referring to FIG. 1, the light emitting diode driving apparatus or the light emitting diode lighting apparatus 100 according to the embodiment of the present invention may include a power supplying unit 120, a driving unit 130, a noise current absorbing unit 140, and a dimmer 110 controlling a phase of an alternating current (AC) power and providing a rectified power. As the dimmer 110, a phase-cut dimmer such as a triac dimmer controlling the phase of the AC power may be used. Hereinafter, a detailed description of the dimmer 110 will be omitted, and the light emitting diode driving apparatus according to the embodiment of the present invention will be described in detail.

The light emitting diode driving apparatus 100 according to the embodiment of the present invention may include the power supplying unit 120, the driving unit 130, and the noise current absorbing unit 140. Here, the power supplying unit 120 may receive a phase-controlled power from the dimmer 110, convert the received power into driving power used for a driving operation of the driving unit 130, and then supply the converted power to the driving unit 130.

The driving unit 130 may include first to N-th drivers 131 to 13N, wherein the first to N-th drivers 131 to 13N may include switching units 131a to 13Na to driving controlling units 131b to 13Nb, respectively.

The first to N-th drivers 131 to 13N may drive light emitting diodes, respectively. For example, a light emitting diode unit may include at least one light emitting diode, preferably, a light emitting diode array having a plurality of light emitting diodes connected to each other in series, and first to N-th light emitting diodes LED1 to LEDN of the light emitting diode array may be driven by the first to N-th drivers 131 to 13N corresponding thereto, respectively. More specifically, when a voltage level of the power phase-controlled by the dimmer 110 is equal to or higher than a voltage level capable of turning on a first light emitting diode LED1, the first light emitting diode LED1 may be first turned on. At the same time, the first driver 131 may drive the first light emitting diode LED1 so that an appropriate current flows to the first light emitting diode LED1.

The first to N light emitting diodes LED1 to LEDN may be sequentially turned on according to the voltage level of the phase-controlled power, and corresponding drivers of the first to N-th drivers 131 to 13N may drive corresponding light emitting diodes, respectively. In a period in which the voltage level of the phase-controlled power drops from a maximum voltage, the N-th to first LEDN to LED1 may be sequentially turned off. Therefore, similarly, corresponding drivers of the first to N-th drivers 131 to 13N may drive corresponding light emitting diodes, respectively.

To this end, the first to N-th drivers 131 to 13N may include switching units 131a to 13Na to driving controlling units 131b to 13Nb, respectively, wherein the switching units 131a to 13Na may include at least one switch M1 and be connected between a cathode of a corresponding light emitting diode and a ground, respectively. More specifically, a detecting resistor Rcs for detecting a current flowing to the light emitting diode may be connected between the switch M1 and the ground.

The driving controlling units 131b to 13Nb may include a comparator comparing a voltage detected by the detecting resistor Rcs and a preset reference voltage VREF and inverters M2 and M3 receiving a driving power to invert an output of the comparator, respectively.

The inverters M2 and M3 may include a p-channel metal oxide semiconductor (PMOS) switch M2 and an n-channel MOS (NMOS) switch M3, wherein the PMOS switch M2 may have a source receiving a driving power VDD from the power supplying unit 120 and a drain connected to a drain of the NMOS switch M3 and the NMOS switch M3 may have a source connected to the ground. The output of the comparator may be provided to the gates of the PMOS switch M2 and the NMOS switch M3. Therefore, when the output signal of the comparator is a high level, the NMOS switch M3 is turned on, such that an output voltage may reach a voltage level of the ground, and when the output signal of the comparator is a low level, the PMOS switch M2 is turned on, such that the output voltage may reach a voltage level of the driving power.

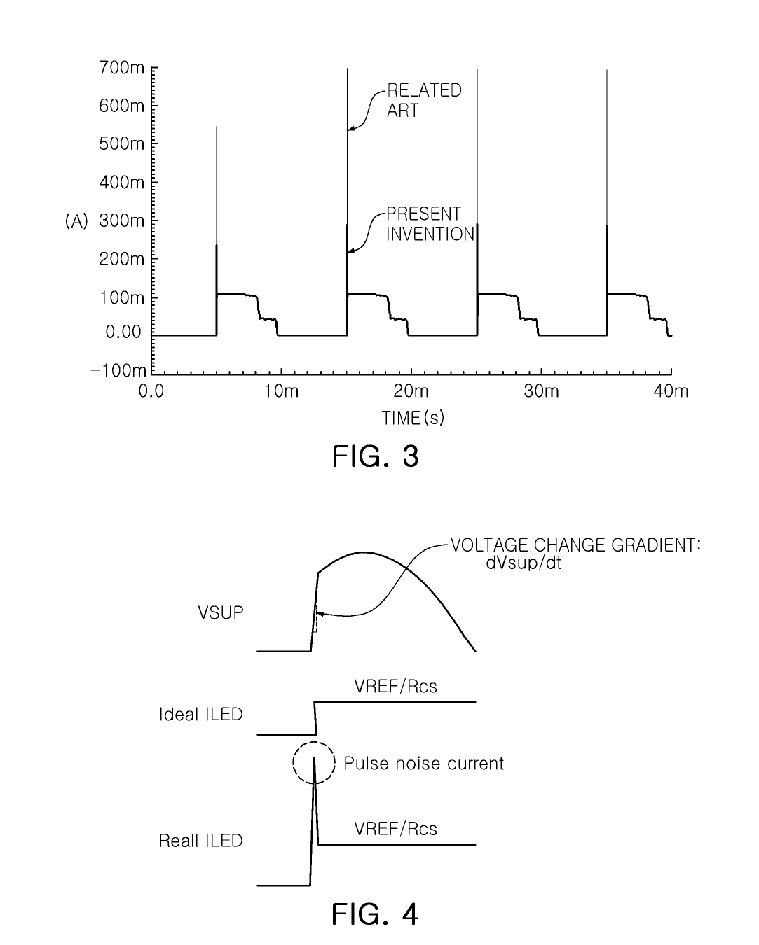

Meanwhile, FIG. 3 is a view illustrating a generation of a noise current.

Referring to FIG. 3, due to a waveform of the phase-controlled power VSUP from the dimmer 110, ideally, the current flowing to the light emitting diode may rise in a stepwise manner from ‘0’ to a driving level VREF/Rcs. However, realistically, a pulse noise current may be generated by a gradient (dVsup/dt) of the waveform of the power by the phase control.

Described in detail, the switch M1 of the switching units 131a to 13Na may have a parasitic capacitance Cgd between a drain and a gate thereof and a parasitic capacitance Cdb between the drain and a body thereof. In the case in which the waveform of the phase-controlled power VSUP rises at a gradient dVsup/dt as shown, displacement currents may be generated in the respective parasitic capacitances and magnitudes of the respective currents may be predicted as represented by the following Equation 1.

I1=Cdg*dVsup/dt,

I2=Cdb*dVsup/dt (Equation 1)

Since the displacement currents I1 and I2 of the respective parasitic capacitances are due to the switch formed of a metal oxide semiconductor field effect transistor (MOSFET), it may be difficult to remove the displacement currents I1 and I2 according to characteristics of the switch.

However, when the displacement current I1 is generated by the parasitic capacitance Cgd between the drain and the gate, a portion of the displacement current may be reused as the driving power VDD through a parasitic diode D1 of the PMOS switch M2 of the driving controlling units 131b to 13Nb.

The driving power VDD is not normally controlled in a short time in which the power supplying unit 120 is not normally operated immediately after the voltage level of the phase-controlled power VSUP rises rapidly, such that the voltage level rises by the displacement current I1 by the parasitic capacitance Cgd between the drain and the gate. As a result, a voltage level of a gate voltage Vgate applied to the switch M1 rises by the sum of a voltage level of the driving power VDD and a diode drop voltage of the parasitic diode D1 of the PMOS switch M2, such that the switch M1 may be conducted. Therefore, an undesired current I3 may flow, such that impact may be applied to a corresponding light emitting diode.

To this end, the noise current absorbing unit 140 may absorb a current by a rapid rise in the voltage level of the phase-controlled power VSUP.

That is, the voltage level of the driving power VDD is lowered at a point in time at which the voltage level of the phase-controlled power VSUP rapidly rises to lower the voltage level of the gate voltage Vgate applied to the switch M1, whereby the excessively generated current I3 may be suppressed.

The noise current absorbing unit 140 may include a first capacitor C1, a first resistor R1, and a noise current switch M4.

In the case in which the voltage level of the phase-controlled power VSUP rapidly rises (dVsup/dt), the first capacitor C1 may be charged with the phase-controlled power VSUP. Therefore, a current I4 may be generated. The current I4 generates a voltage by the first resistor R1, and the voltage is applied to a gate of the noise current switch M4, such that a gate voltage Vgs4 of the noise current switch M4 may be represented by the following Equation 2.

Vgs4=R1*C1*dVsup/dt (Equation 2)

In the case in which the gate voltage Vgs4 is equal to or higher than a threshold voltage at which the noise current switch M4 is conducted, the noise current switch M4 may be conducted to bypath the displacement current I1 by the parasitic capacitance Cgd between the drain and the gate of the switch M1 to the ground, thereby absorbing the noise current. When the pulse noise current is not generated by the gradient dVsup/dt of the waveform of the power by the phase control, the noise current switch M4 may maintain a switching off operation.

Meanwhile, since the voltage of the phase-controlled power VSUP is a high voltage of several hundreds of volts, the first capacitor C1 should endure the high voltage, which may increase a circuit area and a manufacturing cost and make it slightly difficult to implement the above-mentioned circuit structure in the case of integrating the above-mentioned circuit structure using a semiconductor process.

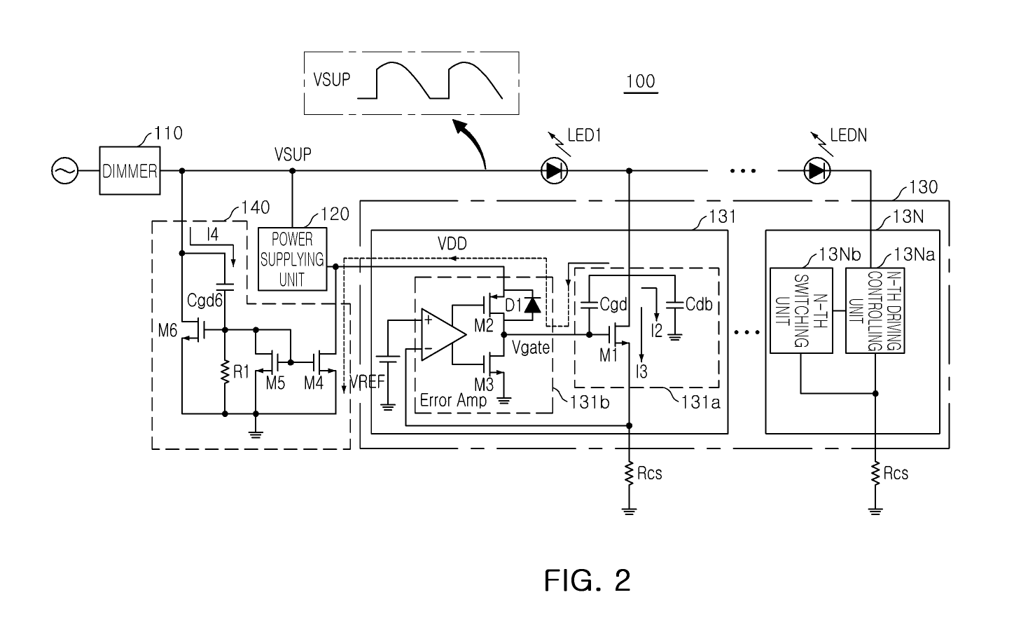

In order to solve this problem, a light emitting diode driving apparatus or a light emitting diode lighting apparatus according to another embodiment of the present invention shown in FIG. 2 will be described.

FIG. 2 is a schematic circuit diagram illustrating a light emitting diode driving apparatus or a light emitting diode lighting apparatus according to another embodiment of the present invention.

Referring to FIG. 2, the light emitting diode driving apparatus or the light emitting diode lighting apparatus according to another embodiment of the present invention may be different in a configuration of a noise current absorbing unit from the light emitting diode driving apparatus or the light emitting diode lighting apparatus according to the embodiment of the present invention. Since a configuration of the light emitting diode driving apparatus or the light emitting diode lighting apparatus according to another embodiment of the present invention except for the noise current absorbing unit is the same as that of the light emitting diode driving apparatus or the light emitting diode lighting apparatus according to the embodiment of the present invention, a detailed description thereof will be omitted.

The noise current absorbing unit 140 shown in FIG. 2 may include first and second switches M6 and M5 instead of the first capacitor C1, wherein the first switch M6 receives a phase-controlled power VSUP, such that a parasitic capacitor Cgd6 of a first switch M6 may be charged with a generated current I4.

In the case in which a voltage level of the phase-controlled power VSUP rapidly rises (dVsup/dt), the generated current I4 may be represented by the following Equation 3.

I4=Cgd6*dVsup/dt (Equation 3)

When a resistance value of a first resistor R1 is significantly larger, most of the current I4 may flow to the second switch M5, and when a size ratio of the first switch M6 to the second switch M5 is 1:N, a current Idm4 absorbed by the noise current switch M4 may be represented by the following Equation 4.

Idm4=N*Cgd6*dVsup/dt (Equation 4)

Here, when a condition in which the noise absorbing current Idm4 is equal to or higher than a displacement current I1 due to parasitic capacitance Cgd between a gate and a drain of a switch M1 is satisfied, an increase in a gate voltage Vgate of the switch M1 may be effectively suppressed.

FIG. 4 is a graph illustrating electrical characteristics of the light emitting diode driving apparatus or the light emitting diode lighting apparatus according to the embodiment of the present invention.

Referring to FIG. 4, it could be seen that a peak value of a current flowing to a current source (switch) of a light emitting diode is significantly decreased in the light emitting diode driving apparatus or the light emitting diode lighting apparatus according to the embodiment of the present invention as compared with the related art. More specifically, it could be seen that a peak current of about 700 mA according to the related art is decreased about 2.4 times.

As set forth above, according to the embodiments of the present invention, the noise current generated according to the power by the phase control of the dimmer is absorbed, whereby reliability of the light emitting diode and the dimmer may be improved.

While the present invention has been shown and described in connection with the embodiments, it will be apparent to those skilled in the art that modifications and variations can be made without departing from the spirit and scope of the invention as defined by the appended claims.

What is claimed is:

1. A light emitting diode driving apparatus comprising:
a power supplying unit receiving a phase-controlled power and supplying a preset driving power;
a driving unit receiving the driving power from the power supplying unit to drive a light emitting diode unit receiving the phase-controlled power; and
a noise current absorbing unit suppressing an increase in a voltage level of the driving power supplied to the driving unit by the phase-controlled power.

2. The light emitting diode driving apparatus of claim 1, wherein the driving unit includes at least one driver driving a corresponding light emitting diode,
the at least one driver including:
a switching unit having a switch switching a path of a current flowing to a corresponding light emitting diode of the light emitting diode unit; and
a driving controlling unit receiving the driving power and comparing a detection voltage obtained by detecting the current flowing to the light emitting diode by conduction of the switch with a preset reference voltage to control driving of the corresponding switching unit.

3. The light emitting diode driving apparatus of claim 1, wherein the light emitting diode unit includes a plurality of light emitting diodes connected to each other in series, and
the driving unit includes a plurality of drivers driving corresponding light emitting diodes, respectively,
each of the plurality of drivers including:
a switching unit switching a switch switching a path of a current flowing to the corresponding light emitting diode; and
a driving controlling unit receiving the driving power and comparing a detection voltage obtained by detecting the current flowing to the light emitting diode by conduction of the switch with a preset reference voltage to control driving of the corresponding switching unit.

4. The light emitting diode driving apparatus of claim 2, wherein the noise current absorbing unit absorbs a current flowing to a parasitic capacitor of the switch to suppress an increase in a voltage level of the driving power supplied to the driving unit.

5. The light emitting diode driving apparatus of claim 4, wherein the noise current absorbing unit includes:
a first capacitor charged with the phase-controlled power;
a first resistor providing a voltage according to a current flowing from the first capacitor; and
a current absorbing switch receiving the voltage from the first resistor at a gate thereof to thereby be conducted and absorbing a current flowing backward to the power supplying unit due to parasitic capacitance of the switch.

6. The light emitting diode driving apparatus of claim 4, wherein the noise current absorbing unit includes:
a first switch receiving the phase-controlled power;
a first resistor providing a voltage according to a current flowing due to parasitic capacitance of the first switch;
a second switch receiving the voltage from the first resistor at a gate thereof to thereby be conducted; and
a current absorbing switch receiving the voltage from the first resistor at a gate thereof to thereby be conducted and absorbing a current flowing backward to the power supplying unit due to parasitic capacitance of the switch according to a preset ratio between the first and second switches.

7. The light emitting diode driving apparatus of claim 3, wherein the noise current absorbing unit absorbs a current flowing to a parasitic capacitor of the switch to suppress an increase in a voltage level of the driving power supplied to the driving unit.

8. The light emitting diode driving apparatus of claim 7, wherein the noise current absorbing unit includes:
a first capacitor charged with the phase-controlled power;
a first resistor providing a voltage according to a current flowing from the first capacitor; and
a current absorbing switch receiving the voltage from the first resistor at a gate thereof to thereby be conducted and absorbing a current flowing backward to the power supplying unit due to parasitic capacitance of the switch.

9. The light emitting diode driving apparatus of claim 7, wherein the noise current absorbing unit includes:
a first switch receiving the phase-controlled power;
a first resistor providing a voltage according to a current flowing due to parasitic capacitance of the first switch;
a second switch receiving the voltage from the first resistor at a gate thereof to thereby be conducted; and
a current absorbing switch receiving the voltage from the first resistor at a gate thereof to thereby be conducted and absorbing a current flowing backward to the power supplying unit due to parasitic capacitance of the switch according to a preset ratio between the first and second switches.

10. A light emitting diode lighting apparatus comprising:
a dimmer controlling a phase of an alternating current (AC) power;
a power supplying unit receiving the phase-controlled power from the dimmer and supplying a preset driving power;
a driving unit receiving the driving power from the power supplying unit to drive a light emitting diode unit receiving the phase-controlled power; and
a noise current absorbing unit suppressing an increase in a voltage level of the driving power supplied to the driving unit by the phase-controlled power.

11. The light emitting diode lighting apparatus of claim 10, wherein the driving unit includes at least one driver driving a corresponding light emitting diode,
the at least one driver including:
a switching unit having a switch switching a path of a current flowing to a corresponding light emitting diode of the light emitting diode unit; and
a driving controlling unit receiving the driving power and comparing a detection voltage obtained by detecting the current flowing to the light emitting diode by conduction of the switch with a preset reference voltage to control driving of the corresponding switching unit.

12. The light emitting diode lighting apparatus of claim 10, wherein the light emitting diode unit includes a plurality of light emitting diodes connected to each other in series, and
the driving unit includes a plurality of drivers driving corresponding light emitting diodes, respectively,
each of the plurality of drivers including:
a switching unit switching a switch switching a path of a current flowing to the corresponding light emitting diode; and
a driving controlling unit receiving the driving power and comparing a detection voltage obtained by detecting the current flowing to the light emitting diode by conduction of the switch with a preset reference voltage to control driving of the corresponding switching unit.

13. The light emitting diode lighting apparatus of claim 11, wherein the noise current absorbing unit absorbs a current flowing to a parasitic capacitor of the switch to suppress an increase in a voltage level of the driving power supplied to the driving unit.

14. The light emitting diode lighting apparatus of claim 13, wherein the noise current absorbing unit includes:
a first capacitor charged with the phase-controlled power;
a first resistor providing a voltage according to a current flowing from the first capacitor; and
a current absorbing switch receiving the voltage from the first resistor at a gate thereof to thereby be conducted and absorbing a current flowing backward to the power supplying unit due to parasitic capacitance of the switch.

15. The light emitting diode lighting apparatus of claim 13, wherein the noise current absorbing unit includes:
a first switch receiving the phase-controlled power;
a first resistor providing a voltage according to a current flowing due to parasitic capacitance of the first switch;
a second switch receiving the voltage from the first resistor at a gate thereof to thereby be conducted; and
a current absorbing switch receiving the voltage from the first resistor at a gate thereof to thereby be conducted and absorbing a current flowing backward to the power supplying unit due to parasitic capacitance of the switch according to a preset ratio between the first and second switches.

16. The light emitting diode lighting apparatus of claim 12, wherein the noise current absorbing unit absorbs a current flowing to a parasitic capacitor of the switch to suppress an increase in a voltage level of the driving power supplied to the driving unit.

17. The light emitting diode lighting apparatus of claim 16, wherein the noise current absorbing unit includes:
a first capacitor charged with the phase-controlled power;
a first resistor providing a voltage according to a current flowing from the first capacitor; and
a current absorbing switch receiving the voltage from the first resistor at a gate thereof to thereby be conducted and absorbing a current flowing backward to the power supplying unit due to parasitic capacitance of the switch.

18. The light emitting diode lighting apparatus of claim 16, wherein the noise current absorbing unit includes:
a first switch receiving the phase-controlled power;
a first resistor providing a voltage according to a current flowing due to parasitic capacitance of the first switch;
a second switch receiving the voltage from the first resistor at a gate thereof to thereby be conducted; and
a current absorbing switch receiving the voltage from the first resistor at a gate thereof to thereby be conducted and absorbing a current flowing backward to the power supplying unit due to parasitic capacitance of the switch according to a preset ratio between the first and second switches.
